(19) United States
(12) Patent Application Publication
(10) Pub. No.: US 2018/0363358 A1
(43) Pub. Date: Dec. 20, 2018

(54) Bollard Sensor and Activator for High Speed Door

(71) Applicants: Dale R. Hudson, Jamesville, NY (US); Jay Tillman, Southbury, CT (US)

(72) Inventors: Dale R. Hudson, Jamesville, NY (US); Jay Tillman, Southbury, CT (US)

(73) Assignee: Jamas Enterprises LLC, Syracuse, NY (US)

(21) Appl. No.: 15/626,646

(22) Filed: Jun. 19, 2017

(51) Int. Cl. E05F 15/73; E01F 15/00

(52) U.S. Cl. CPC E05F 15/73; E05Y 2900/132; E05F 2015/765; E01F 15/003

(57) ABSTRACT

A sentry-post bollard has one or more divergent photo eye units mounted pivotally within the bollard which emit their beams horizontally and across the width the doorway of a high-speed industrial door or other motorized door. The sentry-post bollard may be used to open the door, hold it open, or both, when a vehicle or person is detected approaching the doorway. The sentry-post bollard may be used as a safety device throughout a facility. Placed at intersections, dock doors, ramp doors, etc., a safety beacon or siren can be activated to warn pedestrians of oncoming motorized traffic. The photo eye units project their beam(s) through a window slot extending circumferentially along the bollard and having a width of a nominal three-quarter inch.

### BACKGROUND OF THE INVENTION

This invention relates to door control systems, especially for overhead doors that open and close based on detection of a vehicle or person in the vicinity of the door. The invention is more particularly directed to a sensor used in connection with a so-called high speed door of a type used in factories, warehouses, and in some parking facilities, which can open when a vehicle approaches and closes after the vehicle has passed through. Example of these can be seen at the web site https://www.rytecdoors.com.

Loading vehicles, such as fork lifts and pallet lifters, are used in bringing goods and materials in or out of a warehouse or other structure, or between rooms in a commercial facility. It is important that these vehicles are detected when they approach or are close to the automatic high speed door so it will open for the vehicle and remain open until the vehicle has passed through. After that the door quickly closes to keep wind, dust, or heat from traveling through the doorway from one space into another. In order to detect the presence of a vehicle approaching the doorway, or a person walking or standing near the doorway, some means of detection needs to be provided with its detection range extending through a space near the floor that would be occupied by the vehicle or person. The high-speed industrial door trade is aware of this need, but has been unable to address it.

### OBJECTS AND SUMMARY OF THE INVENTION

Accordingly, it is an object of the present invention to provide a bollard-based vehicle detection system to control opening and staying open of a high speed door or other motorized door, and which also avoids the drawbacks of the prior art.

It is a further object to provide a safety alert system within a facility to serve as actuator of a safety beacon or siren to warn pedestrians of oncoming motorized traffic within the facility, or entering or leaving the facility.

It is another object to provide a bollard that projects one or more detection beams horizontally across the width of the doorway to detect vehicles or person approaching the door.

It is still another object to provide a sturdy platform for the detector, in the form of a sturdy steel bollard, that can withstand collisions with forklift trucks and other industrial vehicles without interrupting their sensing and control operations.

It is a more specific object to provide the door detecting and control arrangement in a bollard which is of simple construction, with clean lines and will not interfere with the operations of the industrial vehicles and personnel in the warehouse or other structure.

In accordance with one aspect of the present invention, a bollard-based sensor is adapted to be installed adjacent a high-speed door, e.g., a door separating two spaces in a warehouse, or in some cases a loading dock door and to cause the door to open or to be held open when a vehicle or some person is in the vicinity of the high-speed door. The bollard has a vertical tubular metal bollard body (typically cylindrical, but possibly of other shapes); and may have a base plate that serves as a means for affixing the tubular metal body of the bollard to a horizontal floor surface. One or more window cutouts at an upper end of the bollard tubular metal body may be present, located to permit the electric eye, i.e. divergent photo eye or eyes to look out across the width of the doorway to detect a vehicle or person approaching the door or present in a space near the door. A fixed plate is welded or otherwise affixed onto the inside surface of the tubular metal body below the window cutout. A pylon or pedestal is fastened onto the plate at the axis of the bollard body and one or more support plates for the photo eyes are pivotally mounted on the top of the pylon or pedestal, at the level of the window cutout. These support plates allow the divergent photo eyes to be aimed at various angles, as appropriate to the installation. Favorably there may be an open core to accommodate for electrical connections to conductors within the bollard body, and there may be a threaded hole provided onto which a conduit may be threadably fitted for wiring leading to the door control arrangement for the high-speed industrial door.

Favorably, the bollard body may be comprised of a steel pipe, preferably a schedule 40 pipe, and this may be embedded in the floor of the space, or may have a footpiece plate or flange bolted to the floor, or alternatively the bollard may be strapped, clamped or welded to an existing structure, i.e., the protective “goalpost” of the door. The window cutout may be approximately 36 inches above the floor, so that the beams extend out at that height from the floor. In a favorable embodiment, the window cutouts are each about ⅝ inch in height and occupy about 80 degrees of arc. Favorably, the bollard body is positioned about 30 inches from the door, but this distance is not critical, and depends on the specifics of the installation. On an indoor setting, there would be one or more sensing bollards on each side of the door to control opening and holding open from either direction.

The bollard can also have a plastic protective sleeve fitted over its tubular metal body, and the plastic sleeve would have a window cutout therein aligned with the window cutout of the tubular metal body. A cap for the bollard may have a small steady or flashing light on its top to indicate that the bollard sensor is on. The bollard sensor may be connected to the door control system for both door opening and holding open, or for opening only or holding open only, as is needed for the given installation.

Preferably, the sensor e.g., divergent photo eye unit is operative to detect light (e.g., infrared) reflected from the approaching vehicle. The beam for the photo eye extends the width of the doorway. The photo eyes can be adjusted to detect between one foot and thirteen feet away from the photo eye. As described, the photo eyes beams see through a ⅝ inch viewing slot that is about 36 inches above the floor, so they would react to a vehicle or person, but not to a small animal or an object rolling on the floor.

An acoustic sensor, such as an ultrasonic or sonic detector, may possibly be used in some applications, rather than the photo eye here, which is typically sensitive to the infrared wavelengths.

In some applications there may be one sensing bollard at the left side of the doorway and another at the right side.

The above and many other objects, features, and advantages of this invention will be more fully appreciated from the ensuing description of a preferred embodiment, which is to be read in conjunction with the accompanying Drawing.

### BRIEF DESCRIPTION OF THE DRAWING

FIG. 1 is a perspective view of an interior industrial doorway, including a vertical high speed door with protective goal-post pipe bollard protecting the right and left sides of the door opening, and a sentry-post detecting bollard that is configured according to one embodiment of the present invention.

FIG. 2 is a front perspective view of the sentry-post bollard of this embodiment.

FIG. 3 is a plan view of a pair of pivotable support plates employed in this embodiment.

FIG. 4 a perspective view of the sentry-post of this embodiment, partly cut away to expose a support pedestal and the pivotable support plates.

FIG. 5 is another perspective view of the detection bollard positioned relative to and associated goal-post pipe bollard and door frame in this embodiment.

FIG. 6 is a top plan view of the sentry-post bollard with top removed to show the inner support mechanism for the divergent photo eyes.

FIG. 7 is a partial perspective view of a portion of the sentry-post bollard.

FIG. 8 is a schematic top view of the high speed door and sensing bollards of this invention.

FIG. 9 is another schematic top view of the high speed door and sensing bollard according to another arrangement of this invention.

### DETAILED DESCRIPTION OF THE PREFERRED EMBODIMENT

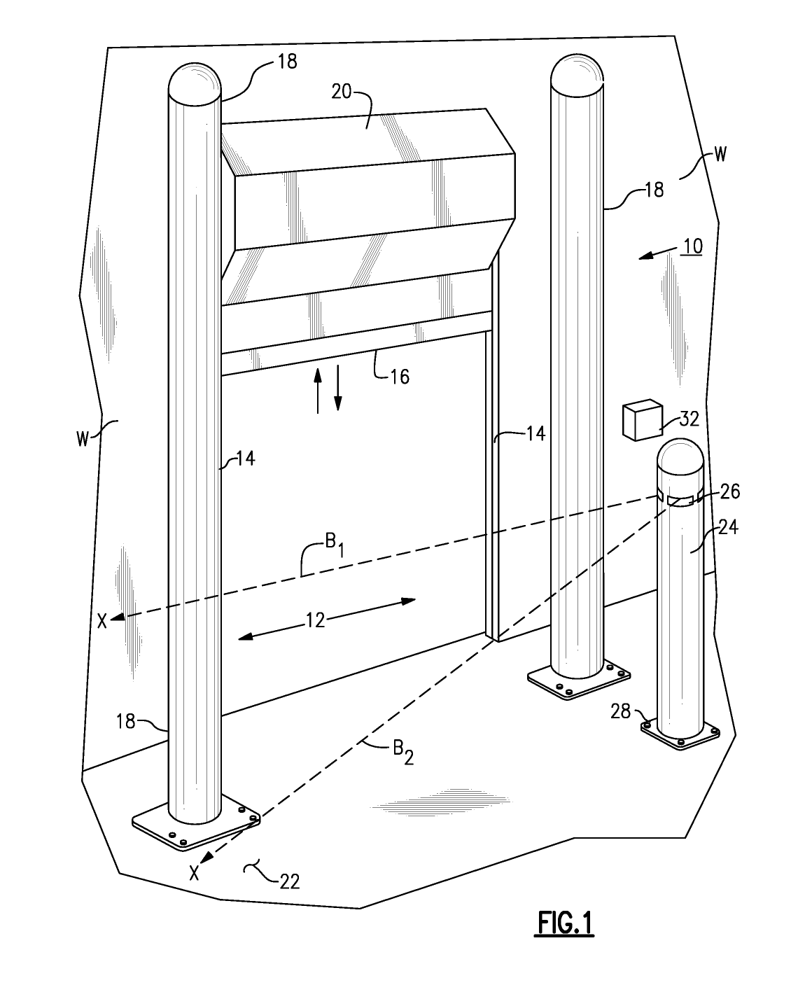

With reference now to the Drawing, FIG. 1 shows the interior of a warehouse or other commercial or industrial building in which a high-speed industrial door 10 is installed in a doorway 12 between rooms or spaces or leading to the exterior of the building, e.g., to a loading dock. Here the doorway is formed in a wall W with a frame 14 positioned on sides of the doorway, forming a trackway in which a door curtain 16 slides up and down to open and close. Here the door opens vertically, but the sentry post detection system of this invention can work equally with side opening industrial doors. At the left and right sides of the doorway there are protective bollards 18 that extend upwards at least to the top of the door, these bollards 18 are frequently referred to as goalposts, due to their resemblance to that structure at sports stadiums. A cover 20 extending across the top of the doorway 12 has within it the mechanisms and windlasses to raising and lowering the door curtain 16.

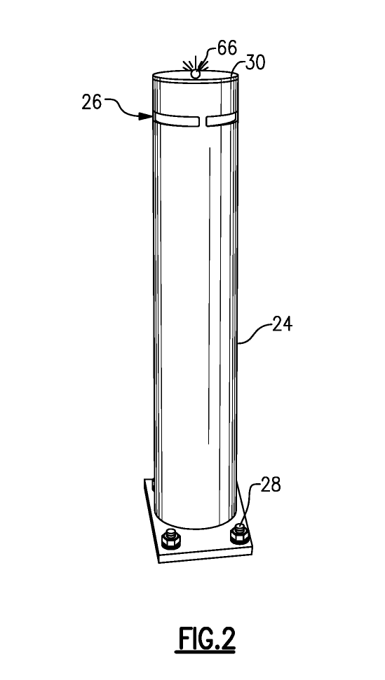

On a floor surface 22, usually a poured concrete flooring, is mounted a sentry post bollard 24, also shown in FIG. 2, positioned to emit an optical detection beam B1, horizontally at about a height of 36 inches above the floor surface 22, and extending a distance across the doorway. The beam B1 is emitted from a diffuse reflection photo eye unit contained within the sentry post bollard 24. In some embodiments there may be two photo eye units, with the second one emitting a second photo beam B2 at an angle to the first beam B1.

The bollard 24 has a window slot 26 formed near the top end through which the diffuse photo eye sends its beam and sees any reflection of it. There may be multiple slots. Favorably each slot 26 extends horizontally for about 80 degrees of arc and has a height of ⅝ inch to one inch, favorably about ¾ inch. The sentry post bollard 24 can be steel pipe or tube, e.g., schedule 40 pipe of four inch to six inch diameter. See also FIG. 5. Optionally the sentry post bollard can have a plastic cover or a protective powder coating. An end cap or plate 30 is attached by screws to the top of the bollard 24. An LED or other visible device 66 can be mounted to the top 30 of the bollard to indicate to status of the door and controller, for example to indicate that the photo eyes are in a detection mode. A flashing or blinking light may indicate an ON status, or the light device 66 may flash a predetermined code to indicate a given status problem.

A controller 32 for raising, lowering, or holding the door curtain 16 open is mounted within a box on the wall W, adjacent the door.

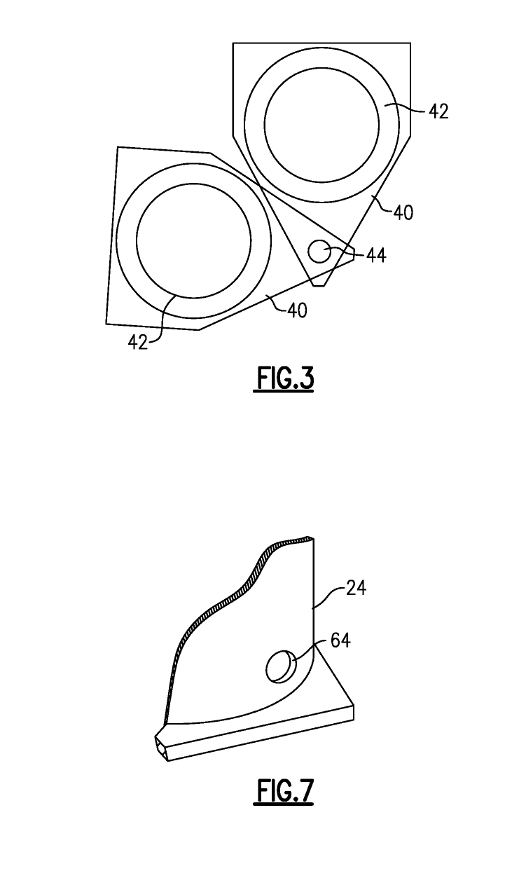

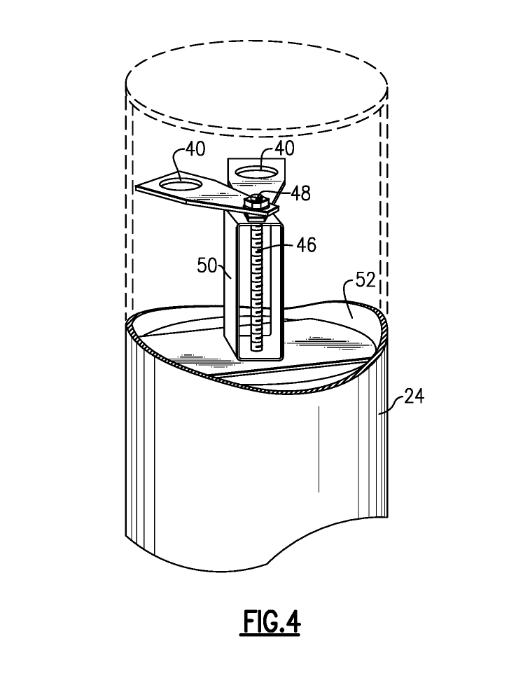

Shown in FIGS. 3 and 4, there may be one or two mounting plates 40 for mounting the diffuse photo eyes within the bollard and permitting them to swivel about the axis of the bollard 24 so they can be properly aimed. Each mounting plate 40 has a radially outward opening 42 for mounting the respective photo eye, and a pivot post opening 44 at the inner end. This opening is configured to fit over a mounting post.

As shown in FIG. 4, a pedestal or stand-off 50 is mounted onto a horizontal fixed plate 52 that is welded or otherwise affixed onto the interior surface of the sentry post bollard a few inches below the position of the window slot or slots 26. A threaded post 46 passes through the plate 52 and then through the openings 44 of the mounting plates 40 and these are secured in place with a threaded nut 48. This arrangement permits the mounting plates to be pivoted independently to any desired angle so the associated photo eye units can be aimed as required for the given installation. The height of the pedestal 50 is selected so that the view of the photo eye units is aligned with the window slot or slots 26.

FIG. 5 shows the sentry post bollard 24 installed at one side of the high speed industrial door, just out from that position of the goalpost bollard 18 and a short distance to the right of it, with the door controller 32 behind it on the wall. The position for the sentry post bollard is selected based on traffic patterns within the warehouse or other facility. The goal post bollard 24 can be armed directly onto the goalpost bollard in some cases, or can be clamped to it or to other structure.

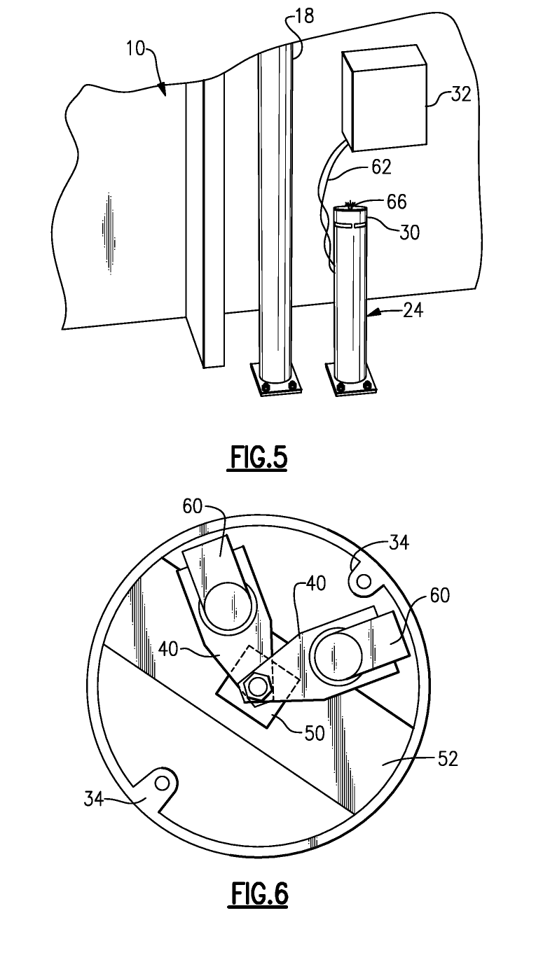

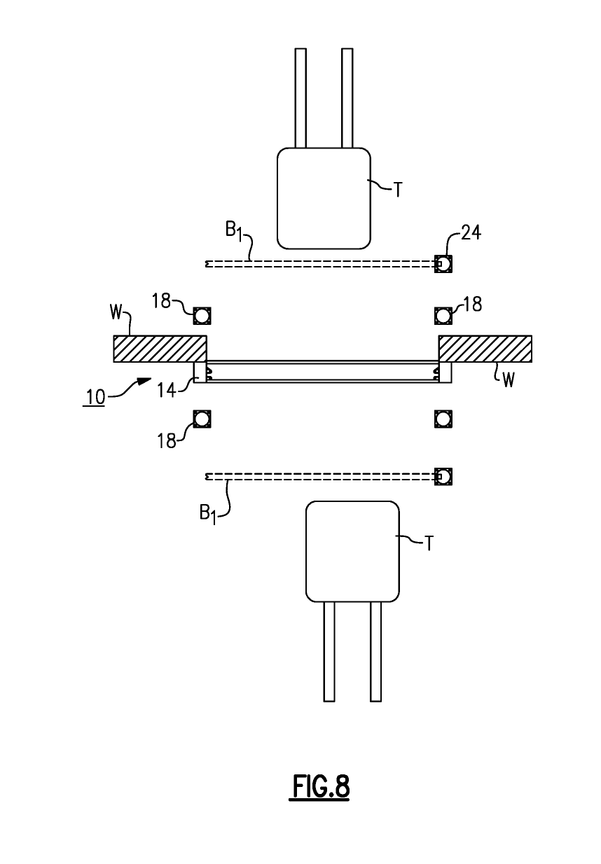

FIG. 6 illustrates the sentry post bollard 24 with its cap 30 removed. As shown here, there are a pair of lugs 34 welded at diametrically opposed positions in the bollard pipe, with threaded openings to receive hold-down bolts for the cap 30. Here are shown a pair of diffusive photo eyes 60, each positioned in a respective one of the two mounting plates 40. The plates 40 and photo eyes 60 can be aimed by rotating them about pivot openings 44 on the pedestal or stand off 50. One or both photo eyes 50 may be used, depending on the particular application at the given door 10. Favorably, the photo eye may be an Eaton Cutler Hammer 10-foot diffuse reflective photo sensor, which produces a three-meter diffuse reflective beam of about a three-degree width. These are connected by a cable 62 to controller 32, and the cable may favorably pass via a threaded conduit that screws into a threaded opening 64 at the base of the sentry post bollard 24 (see FIG. 7).

The sentry post bollard 24 in this embodiment is in the form of a tubular cylindrical body, but in other embodiments the bollard 24 may take the form of a square pipe, a pipe of oval profile, or another suitable shape.

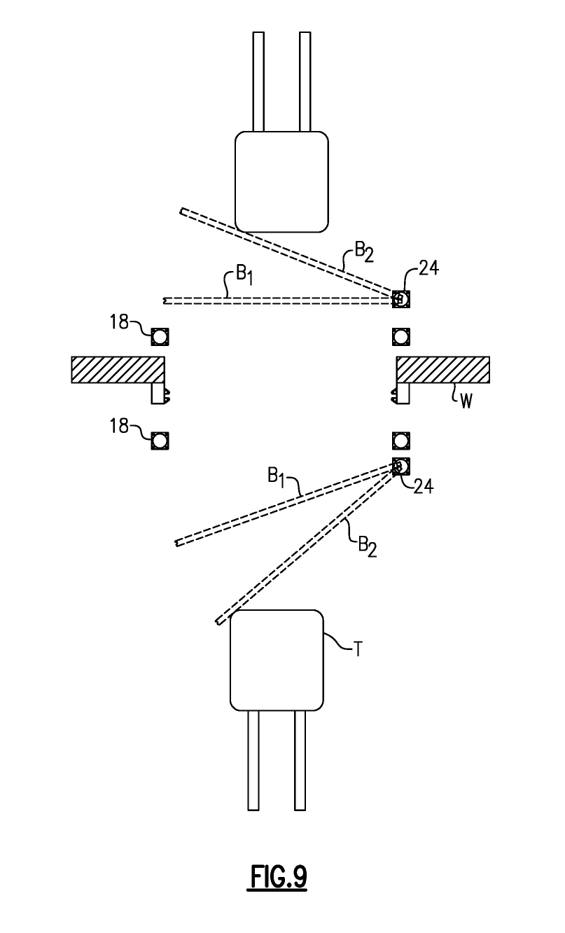

FIG. 8 is a plan view showing single-beam arrangement. On each side of the partition wall W there is a sentry post bollard 24 each sending a single detection beam B1 across the width of the doorway 12. Each of the two sentry post bollards is positioned relative to the doorway 12 so as to detect the presence of a lift truck T or other moving item (e.g., pallet loader or person) before the moving item reaches the door; in this case, the bollards 24 are spaced about 46 inches respectively out away from the door. Other components of the earlier-described arrangements are identified with the same reference characters as used there.

A twin-beam arrangement of the invention is illustrated in FIG. 9, where again the same elements or components are identified with the same reference numbers and need not be described in detail. In this arrangement, as in FIG. 8, there is a sentry post bollard 24 disposed on each side of the partition wall W, and each of the sentry post bollards 24 is spaced about 30 inches from the high speed industrial door on its respective side. As mentioned before, the two beams B1, B2 of each sentry post bollard can be aimed independently at an angle determined to be most suitable for the particular installation. In this example, on one side (upper part of drawing the sentry post bollard has beam B1 aimed transversely, i.e., parallel to the wall W and the doorway, and the other beam B2 is aimed about 15 to 20 degrees out away from the wall W, so as to intercept the lift truck T before it reaches the first beam B1. On the other side, beam B1 may be angled out at about 20 degrees and the other beam B2 angled out at about 40 degrees. The particular angle for each photo eye beam would be determined to match the expected traffic patterns in each room or space. In any event, the sentry-post bollard 24 on one side that first detects the approach of the truck T or other moving item will cause the door controller to open the vertical door, and the sentry-post bollard on the other side will serve to hold the door open until the truck T has passed entirely through the door and beyond the beam B1 or B2 of the other sentry-post bollard 24.

While the invention has been described with reference to specific preferred embodiments, the invention is certainly not limited to those precise embodiments. Rather, many modifications and variations will become apparent to persons of skill in the art without departure from the scope and spirit of this invention, as defined in the appended claims.

What is claimed is:

1. An industrial door activation and/or hold-open device, adapted for use in a building structure to control a motorized door that is positioned at a doorway formed through a wall, said doorway having a predetermined height and a predetermined width and said building having a substantially horizontal floor surface at said doorway, the motorized door including a controller to control the opening and closing of the door; the industrial door activation and/or hold-open device comprising:
a bollard including a vertical tubular rigid bollard body having a base, means for affixing said bollard in place on or above said horizontal floor surface; the bollard being aligned approximately at one side edge of said doorway and a predetermined distance spaced from said wall;
a window cutout formed in said vertical tubular rigid bollard body at a predetermined height above said horizontal floor surface, said height being selected to match approximately an expected visible portion of a vehicle or person approaching said doorway,
at least one optical divergent photo eye mounted within tubular bollard body at the vertical height of said window cutout, said photo eye being positioned to emit an optical beam through said window cutout and directed horizontally and across the width of said doorway at said predetermined vertical height, and configured to detect presence of either of said vehicle or person intercepting said beam; and
circuitry connecting said at least one optical divergent photo eye with said controller and to provide an actuation signal to the controller such that the presence of either of said vehicle or person intercepting said beam causes the door to open, or to be held open, or both.

2. The industrial door activation and/or hold-open device according to claim 1 wherein said bollard body includes a steel pipe.

3. The industrial door activation and/or hold-open device according to claim 2 wherein said bollard body has a threaded hole formed at a lower portion thereof and adapted for attaching a threaded electrical conduit.

4. The industrial door activation and/or hold-open device according to claim 2 comprising a mounting arrangement within said bollard on which said optical divergent photo eye is mounted, including a base member affixed onto an inner surface of the bollard below said window cutout; a pedestal affixed at its lower end onto said base member and rising along a central axis of said bollard; and at least one mounting plate having one end pivotally mounted on a top of said pedestal, and having a receptacle formed therein in which said divergent photo eye is held at a position to emit said optical beam through said window cutout.

5. The industrial door activation and/or hold-open device according to claim 4, wherein said at least one mounting plate includes two mounting plates, each independently pivotably mounted onto said pedestal and each supporting a respective one of two divergent photo eyes.

6. The industrial door activation and/or hold-open device according to claim 1 wherein said window cutout has a vertical extent of substantially ⅝ inch and extends horizontally for substantially 80 degrees of arc.

7. The industrial door activation and/or hold-open device according to claim 1 wherein said window cutout is positioned substantially thirty-six inches above said floor surface.

8. The industrial door activation and/or hold-open device according to claim 7 wherein said bollard is positioned on said floor surface substantially thirty inches from said wall.
